(19) United States
(12) Patent Application Publication
(10) Pub. No.: US 2004/0015374 A1
(43) Pub. Date: Jan. 22, 2004

(54) Method for active transportation management based on cell broadcast

(76) Inventor: Rolf Hager, Remagen-Oedingen (DE)

Correspondence Address: Myron Greenspan, Lackenbach Siegel, One Chase Road, Scarsdale, NY, 10583, US

(21) Appl. No.: 10/399,601

(22) PCT Filed: Oct. 12, 2001
(86) PCT No.: PCT/DE01/03886

(30) Foreign Application Priority Data
Oct. 18, 2000 (DE) 100 51 810.9

(51) Int. Cl. G06F 17/60

(52) U.S. Cl. 705/6; 705/13

(57) ABSTRACT

The invention relates to a method for active transportation management. According to this method, a transportation centre is established and receives potential transportation orders from clients with the transportation data and parameters and converts the transportation data that are associated with the transportation orders into an electronic message. Said message is emitted within a predetermined area by means of a mobile telecommunications system and can be received by suitable receiving devices.

The invention relates to a method for an active transport management based on cell broadcast according to the preamble of patent claim 1.

A multiplicity of so-called transport or fleet management systems has been available up to now. However, these are not of an active nature, i.e. to avoid empty driving the driver had to pick up a new order at the customer or fleet manager or, alternatively, he automatically received from the fleet manager of the same company a succeeding order. In this case, however, he must belong to the fleet.

The invention addresses the task of proposing a method for an active transport management with which to all relevant vehicles, independently of any fleet or company association, a transport order can be offered.

The solution of this problem is based on the characteristics of patent claim 1.

According to the invention at least one transport central office is set up, which receives potential transport orders from clients with specification of transport dates and parameters, and which converts the transport data and parameters associated with the transport orders into an electronic message, which, by means of a mobile communication system, is broadcast in a predetermined region and which can be received by suitable receiving devices.

The principle is comparable to that of a taxi center: many motor vehicles within the predetermined region listen to the transport offer, in terms of time the first suitable candidate has the best chance to get the order.

Advantageous further developments and embodiments of the invention are specified in the dependent patent claims.

A digital cell mobile communication system is preferably employed for carrying out the method.

Therewith it is possible to define a region for sending out the message, with the region comprising the area of one or several radio cells of the mobile communication system. The pick-up location is located within the predetermined region, preferably approximately in the center of the region in which the message is being broadcast.

The electronic message can be for example encoded as a newslet which is broadcast via cell broadcast in the previously determined radio cells of the region.

The broadcast message comprising a potential transport order can now be received by suitable receiving devices of motor vehicles located within the region, and, in the event there is interest by the motor vehicle driver, the acceptance of the transport order can take place by establishing a connection via the mobile communication network or in another suitable manner.

A further development of the inventive concept provides that the receiving device provided in the motor vehicle automatically receives incoming transport orders, evaluates them and, at given suitability of the transport order, accepts it by establishing a connection with the transport center.

The automatic evaluation for suitability of the incoming transport orders takes place on the basis of the transmitted transport data and parameters, thereby that these are compared with data and parameters predetermined by the driver of the motor vehicle or with such already predetermined.

The transport data and parameters comprise preferably a precise description of the charge, the pick-up location, the destination location, important transport dates, and specification of remuneration.

After an interest in the transport order has been expressed by the motor vehicle or the driver of the motor vehicle, the transport center transmits an order confirmation to the selected motor vehicle which is been engaged for the transport.

After the order has been awarded, further contract modalities can be negotiated between the transport center and the driver of the motor vehicle.

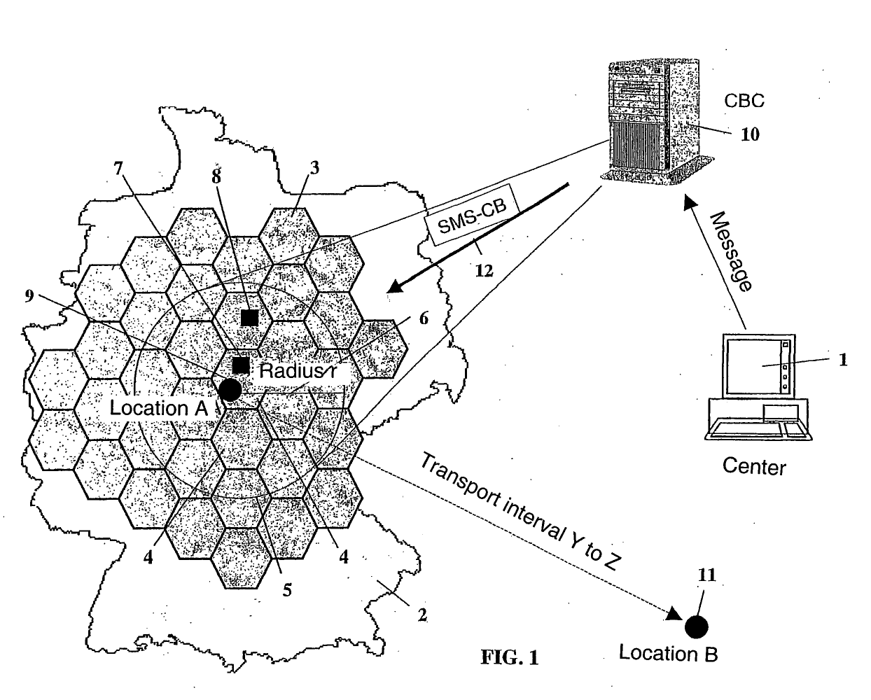

In the following an embodiment example of the invention will be discussed in further detail in conjunction with the drawing FIG. 1, and further characteristics and advantages of the invention will be evident.

The invention permits a transport center 1 to convey transport orders to a number of potentially interested transport motor vehicles 7, 8.

The transport center 1 is responsible for a predetermined region 2, here for example the entire Federal Republic of Germany, and is tied to at least one digital cellular mobile communication system covering the region 2, which comprises a multiplicity of radio cells 3, 4.

In the transport center 1 the transport wishes and orders of clients converge, and each transport order is characterized by data and necessary parameters of the transport. These parameters can be:

specifications regarding charge with description (weight, volume, form, hazard class, etc.);

specifications of pick-up location 9, at which the charge can be accepted;

specification of destination location 11, to which the charge is to be delivered;

time interval Y to Z (for example Y:=yymmdd, hh:mm, for example 000310, 13:00 for starting day and time) in which the transport is to take place;

if appropriate, telephone number or address of the center 1, if the ID of the center of the corresponding CB channel has previously not been clearly agreed to.

In the transport center the above listed parameters of the transport order are converted in suitable manner and incorporated into a conventional short message (SMS) such as can be sent in digital mobile radio networks. This short message 12 is broadcast in the mobile communication network from a short message center 10 via cell broadcast (SMS-CB) 12 within a delimited region 5 substantially determined by the particular pick-up location. This can advantageously be carried out thereby that the SMS message 12 is transmitted to the set of all radio cells 4 located within the region 5, i.e. such as are suitable, via broadcast. A radio cell 4 is suitable if it partially or completely lies within a radius 6 about the pick-up location 9, which radius 6 defines the region 5.

The choice of suitable radio cells 4 within region 5 takes place either directly in the transport center 1, in a dedicated server or directly in the Cell Broadcast Center (CBC) 10. For the choice of radio cells the region 5 does not need to be circular with radius 6, but can have any desired form (rectangle, polygon, etc.). At the later time region 5 can also be made freely selectable via user interface.

The broadcast SMS message 12 can be received by interested transport motor vehicles 7, 8 within region 5. For this purpose the transport motor vehicles 7, 8 must be equipped for example with a mobile radio end terminal. Interested transport motor vehicles 7, 8 are such which are located within a reasonable access radius within region 5. Therefore other transport motor vehicles are excluded, whose access path or length is too great for the desired transport or which are outside of region 5, since these motor vehicles are too far away to even be able to accept the order.

Based on the received message 12, the drivers or motor vehicle managers of the transport motor vehicles 7, 8 receive a potential transport order, which contains sufficient information to be able to judge whether or not the transport is technically even feasible for the driven motor vehicle 7, 8. For example, the charge quantity (volume, weight) could be too large, in which case the motor vehicle is not appropriate.

If the transport is considered appropriate, the driver or the motor vehicle manager reports to the transport center 1 and negotiates all necessary conditions, for example fee, source and target addresses, other information, etc.

A further development of the invention provides that the SMS CB-capable end terminal of the driver (for example laptop with GSM or M20 module or the like) comprises an online application with evaluation logic, which can automatically evaluate the relevant received short messages 12 or respond to them.

The evaluation logic is comprised of a control unit which, if appropriate, can be configured by the driver and which, in conjunction with the data and parameters transmitted in the short message, makes decisions for example of the following type:

“charge suitable” ® send acceptance offer automatically to center through SMS;

“charge suitable” ® send acceptance offer automatically to center through SMS with subsequent automatic connection setup to the center;

“charge suitable” and time window fits into day schedule ® send acceptance offer to center;

“charge not suitable” or “not interested” (can be incorporated via user interface as a flag in the evaluation logic) ® no response and consequently rejection of offer.

The response of the application is thus comprised of several configuratable options which can occur in any grouping:

Sending (immediately or later) of an offer acceptance SMS to the center 1 (the center 1 can also automatically and online assign the order, for example according to the FIFO principle or its own rules);

Starting automatic call to the center 1 (either immediately or later);

Signaling the process with interaction option via user interface to the user.

As soon as from center 1 the definitive order assignment takes place, for example via direct SMS to the end terminal in the motor vehicle or optionally via automatic/manual voice call, the application of the driver confirms via the above listed response options and the agreement is considered concluded.

The precise agreement modalities, including delivery address, charge etc. can be received by the application via SMS and be processed for the driver. Here, if appropriate, further options or parameters for the evaluation logic are given, for example the remuneration for the work can be an exclusion criterion for the acceptance of the order. Overall, the entire method described here can be completely automated and can additionally be optionally equipped to be interactive with user parts.

1. Method for an active transport management, characterized in
that a transport center (1) is set up, which receives potential transport orders from customers with the specification of transport data and parameters,
that the transport center (1) converts the transport data and parameters associated with the transport orders into an electronic message (12), which is broadcast by means of a mobile communication system into a predetermined region (5) and can here be received by suitable receiving devices.

2. Method as claimed in claim 1, characterized in that the mobile communication system is a digital cellular mobile communication system.

3. Method as claimed in claim 1 or 2, characterized in that the predetermined region (5) encompasses the area of one or several radio cells (3; 4) of the mobile communication system.

4. Method as claimed in one of the preceding claims, characterized in that the electronic message (12) is a short message, which is broadcast via cell broadcast.

5. Method as claimed in one of the preceding claims, characterized in that the pick-up location (9) is within the predetermined region (5) in which the message (12) is being broadcast.

6. Method as claimed in one of the preceding claims, characterized in that the electronic message (12) is a voice message which is broadcast via cell broadcast.

7. Method as claimed in one of the preceding claims, characterized in that the message (12) regarding a transport order can be received by suitable receiving devices of motor vehicles (7, 8) located within the region (5), and the acceptance of the transport order takes place by establishing a connection to the transport center (1).

8. Method as claimed in one of the preceding claims, characterized in that the receiving device provided in the motor vehicle (7, 8) automatically receives the broadcast transport orders (12), evaluates them and in the event of the suitability of the transport order, accepts it by establishing a connection with the transport center (1).

9. Method as claimed in one of the preceding claims, characterized in that the evaluation for suitability of the incoming transport orders takes place in conjunction with the transmitted transport data and parameters, in that these are compared with the data and parameters predeterminably by the driver of the motor vehicle (7, 8).

10. Method as claimed in one of the preceding claims, characterized in that the transport data and parameters preferably comprise: precise description of the charge, the pick-up location, the destination sit, important transport dates, and specifications regarding remuneration.

11. Method as claimed in one of the preceding claims, characterized in that the transport center (1) sends an order confirmation to the motor vehicle (7, 8) selected for the order.

12. Method as claimed in one of the preceding claims, characterized in that after the order assignment further agreement modalities are negotiated between the transport center (1) and the driver of the motor vehicle (7, 8).
